(19) United States
(12) Patent Application Publication
(10) Pub. No.: US 2012/0184658 A1
(43) Pub. Date: Jul. 19, 2012

(54) BEAD APEX RUBBER COMPOSITION AND PNEUMATIC TIRE

(76) Inventor: Tatsuya MIYAZAKI, Kobe-shi (JP)

(21) Appl. No.: 13/350,370

(22) Filed: Jan. 13, 2012

(30) Foreign Application Priority Data
Jan. 17, 2011 (JP) 2011-007358

(51) Int. Cl. C08L 7/00

(52) U.S. Cl. 524/420; 524/495

(57) ABSTRACT

The present invention aims to provide a bead apex rubber composition and a pneumatic tire which are capable of improving the handling stability, fuel economy and proccessability in a balanced manner, and preventing deterioration of the handling stability. The bead apex rubber composition includes: a rubber component; a carbon black; and a phenolic resin, wherein the carbon black has a COAN of 95 to 130 ml/100 g and a BET specific surface area of 25 to 50 m²/g.

### TECHNICAL FIELD

The present invention relates to a bead apex rubber composition and a pneumatic tire using the same.

### BACKGROUND ART

Conventional rubber compositions for tire bead apexes have been designed especially to increase the complex elastic modulus (E*) and improve the handling stability (e.g. steering response). However, even if the handling stability is improved, in the case of driving with tires for sport utility vehicles (SUVs) or driving at cold temperatures, deformation strain is stored in the bead apexes of the tires, that is, a flat spot is developed, until the tire temperature is increased after the vehicle stops for a predetermined period of time and then restarts running. As a result, the fuel economy is deteriorated. Such a flat spot can be effectively prevented by reducing the tan δ.

Addition of 1,2-syndiotactic polybutadiene (SPB) crystals is known to increase the E*, but also increases the tan δ disadvantageously. On the other hand, reduction in amounts of fillers such as carbon black is known to reduce the tan δ, but also reduces the E* disadvantageously. Namely, the E* and tan δ are conflicting properties, and therefore it is difficult to improve both of these properties.

As a technique to solve these problems, Patent Document 1 discloses the use of a (modified) phenol resin, non-reactive phenol resin, and carbon black. However, the bead apex still needs to be improved to provide required performance, that is, high performance stability (repeatability) of handling stability (high resistance to permanent set of compound). Further, there is a need for further balanced improvement in the handling stability and fuel economy.

Patent Document 1: JP 2009-127041 A

### SUMMARY OF THE INVENTION

The present invention aims to provide a bead apex rubber composition and a pneumatic tire which are capable of overcoming the above problems, improving the handling stability, fuel economy and proccessability in a balanced manner, and preventing deterioration of the handling stability.

The present invention relates to a bead apex rubber composition including: a rubber component; a carbon black; and a phenolic resin, wherein the carbon black has a MAN of 95 to 130 ml/100 g and a BET specific surface area of 25 to 50 m²/g. Preferably, the phenolic resin is a phenol resin and/or a modified phenol resin.

Preferably, an amount of the carbon black is 40 to 80 parts by mass, and a total amount of the phenol resin and modified phenol resin is 5 to 18 parts by mass based on 100 parts by mass of the rubber component.

Preferably, the rubber component includes butadiene rubber and at least one of natural rubber and isoprene rubber, and an amount of the butadiene rubber is 20 to 80% by mass in 100% by mass of the rubber component.

Preferably, an amount of sulfur is 4 to 8 parts by mass based on 100 parts by mass of the rubber component.

The present invention also relates to a pneumatic tire including a bead apex produced from the rubber composition.

The bead apex rubber composition of the present invention contains a rubber component, a carbon black and a phenolic resin, and the carbon black has a COAN of 95 to 130 ml/100 g and a BET specific surface area of 25 to 50 m²/g. This composition can improve the handling stability, fuel economy and proccessability in a balanced manner and prevent deterioration of the handling stability. Accordingly, it is possible to provide a pneumatic tire excellent in these performances.

### BEST MODE FOR CARRYING OUT THE INVENTION

The bead apex rubber composition of the present invention contains a rubber component, a carbon black and a phenolic resin, and the carbon black has a COAN of 95 to 130 ml/100 g and a BET specific surface area of 25 to 50 m²/g.

The use of a high structure carbon black having a specific COAN and BET specific surface area together with a phenolic resin prevents deterioration of the handling stability such as steering response, and improves the handling stability, fuel economy and proccessability in a balanced manner. The mechanism of such improvement in these performances is still unclear but is presumably that in the case of the high structure carbon black instead of a conventional carbon black, larger or harder composite spheres are formed from the phenolic resin, carbon black and rubber component.

Further, the use of a syndiotactic polybutadiene crystal-containing butadiene rubber as a rubber component results in further higher handling stability and also prevents deterioration of this performance because the syndiotactic crystals intrude into the composite spheres and make the composite spheres very hard. This same effect is further achieved, for example, by increasing the phenolic resin or sulfur to increase the crosslink density, or by reducing oil.

The rubber component may include a diene rubber(s) such as natural rubber (NR), isoprene rubber (IR), butadiene rubber (BR), styrene butadiene rubber (SBR), acrylonitrile butadiene rubber (NBR), chloroprene rubber (CR) and butyl rubber (IIR). Especially, NR and IR are preferred in terms of the tensile strength, heat build-up, curing rate, compatibility with carbon black (dispersibility) and proccessability; BR is preferred in terms of the hardness; and SBR is preferred in terms of the proccessability. More preferred are a combination of BR and at least one of NR and IR, and a combination of SBR and at least one of NR and IR.

The BR is not particularly limited and examples thereof include BR with a high cis-content, and syndiotactic polybutadiene crystal-containing BR (SPB-containing BR). Especially, SPB-containing BR is preferred for good handling stability, extrusion proccessability, adhesion, and fuel economy.

In the case where the rubber component includes SPB-containing BR, the SPB content of the SPB-containing BR is preferably not less than 8% by mass, and more preferably not less than 12% by mass. An SPB content of less than 8% by mass may result in an insufficient processability improving effect. The SPB content is preferably not more than 20% by mass, and more preferably not more than 18% by mass. An SPB content of more than 20% by mass tends to result in lower processability. The SPB content of the SPB-containing BR is calculated based on the boiling n-hexane-insoluble matter content.

Examples of the SBR include emulsion-polymerized styrene butadiene rubber (E-SBR) and solution-polymerized styrene butadiene rubber (S-SBR). Especially, E-SBR is preferred because it provides good proccessability, allows good dispersion of carbon black and is suitably used even in a carbon black-rich composition.

The styrene content of the SBR is preferably not less than 10% by mass, and more preferably not less than 20% by mass. A styrene content of less than 10% by mass may not lead to improvement in the processability and tends to result in insufficient hardness. The styrene content is preferably not more than 40% by mass, and more preferably not more than 30% by mass. A styrene content of more than 40% by mass tends to lead to low fuel economy.

The total amount of NR and IR is preferably not less than 10% by mass, and more preferably not less than 20% by mass in 100% by mass of the rubber component. A total amount of NR and IR of less than 10% by mass may result in insufficient tensile strength. The upper limit of the total amount may be 100% by mass but is preferably not more than 80% by mass, and more preferably not more than 75% by mass. A total amount of more than 80% by mass tends to result in insufficient hardness, and lead to a fast curing rate so that the rubber composition is likely to scorch when extruded.

The amount of BR is preferably not less than 20% by mass, and more preferably not less than 30% by mass in 100% by mass of the rubber component. The amount is preferably not more than 80% by mass, and more preferably not more than 70% by mass.

The amount of SPB-containing BR is preferably not less than 20% by mass, and more preferably not less than 30% by mass in 100% by mass of the rubber component. The amount is preferably not more than 80% by mass, and more preferably not more than 70% by mass.

An amount of BR or SPB-containing BR of less than the lower limit may result in insufficient hardness; and an amount of more than the upper limit tends to result in increased viscosity, poor dispersibility of carbon black and poor extrusion proccessability, and also tends to lead to low fuel economy.

The amount of SBR is preferably not less than 5% by mass, and more preferably not less than 10% by mass in 100% by mass of the rubber component. An amount of SBR of less than 5% by mass may not lead to improvement in the proccessability and tends to result in insufficient hardness. The amount is preferably not more than 80% by mass, and more preferably not more than 50% by mass. An amount of more than 80% by mass tends to lead to low fuel economy.

The rubber composition of the present invention contains a carbon black having a specific COAN and BET specific surface area.

The COAN of the carbon black is not less than 95 ml/100 g and is preferably not less than 100 ml/100 g. A COAN of less than 95 ml/100 g tends to lead to low handling stability. In addition, in this case, the level of this performance tends to significantly change. The COAN is not more than 130 ml/100 g and is preferably not more than 120 ml/100 g. A COAN of more than 130 ml/100 g tends to lead to low fuel economy. In addition, in this case, the viscosity of the rubber composition tends to be increased, likely resulting in low dispersibility of the carbon black.

The COAN of carbon black herein is determined in accordance with ASTM D 3493. Dibutyl phthalate (DBP) is used as oil.

The BET specific surface area of the carbon black is not less than 25 m²/g and is preferably not less than 35 m²/g. A BET specific surface area of less than 25 m²/g tends to lead to low handling stability. In addition, in this case, the level of this performance tends to significantly change. The BET specific surface area is not more than 50 m²/g and is preferably not more than 45 m²/g. A BET specific surface area of more than 50 m²/g tends to lead to low fuel economy.

The BET specific surface area of carbon black herein is determined in accordance with ASTM D 6556.

The DBP oil absorption (OAN) of the carbon black is preferably not less than 100 ml/100 g, and more preferably not less than 130 ml/100 g. A DBP oil absorption of less than 100 ml/100 g tends to lead to low handling stability. In addition, in this case, the level of this performance tends to significantly change. The DBP oil absorption is preferably not more than 250 ml/100 g, and more preferably not more than 200 ml/100 g. A DBP oil absorption of more than 250 ml/100 g may result in insufficient fuel economy.

The DBP oil absorption (OAN) of carbon black herein is determined in accordance with ASTM D 2414.

The carbon black can be produced by conventionally known methods such as the furnace process and channel process.

The amount of the carbon black is preferably not less than 40 parts by mass, and more preferably not less than 55 parts by mass based on 100 parts by mass of the rubber component. An amount of the carbon black of less than 40 parts by mass tends to lead to low handling stability. In addition, in this case, the level of this performance tends to significantly change. The amount is preferably not more than 80 parts by mass, and more preferably not more than 75 parts by mass based on 100 parts by mass of the rubber component. An amount of more than 80 parts by mass may lead to low dispersibility of the carbon black and insufficient fuel economy. In addition, in this case, a large amount of heat is generated in the process of extrusion and therefore an extruded product is likely to scorch or to have a problem in the edge profile.

The rubber composition of the present invention may contain silica. In this case, good adhesion is provided. The silica is not particularly limited and examples thereof include dry silica (silicic anhydride) and wet silica (hydrous silicic acid). Wet silica is preferred because it has more silanol groups.

The nitrogen adsorption specific surface area (N₂SA) of silica is preferably not less than 70 m²/g, and more preferably not less than 80 m²/g. If the N₂SA is less than 70 m²/g, the silica may provide only a small reinforcing effect, presumably resulting in insufficient rubber strength. The N₂SA of silica is preferably not more than 220 m²/g, and more preferably not more than 210 m²/g. If the N₂SA is more than 220 m²/g, the silica tends to have low dispersibility and increase heat build-up.

The nitrogen adsorption specific surface area of silica herein is a value determined in accordance with ASTM D 3037-81 by the BET method.

The upper limit of the amount of silica is preferably not more than 15 parts by mass, and more preferably not more than 10 parts by mass based on 100 parts by mass of the rubber component. If the amount of silica is within the above range, the effects of the present invention are favorably provided. An amount of silica of more than 10 parts by mass tends to lead to lower hardness and more heat build-up in the process of extrusion. In this case, the rubber texture is slightly improved. It should be noted that silica does not contribute to improvement in the performance of the composite spheres.

The rubber composition of the present invention contains a phenolic resin and examples of the phenolic resin include phenol resins and modified phenol resins. The term “phenol resin” is intended to include those obtained by the reaction between phenol and an aldehyde such as formaldehyde, acetaldehyde and furfural in the presence of an acid or alkali catalyst. The term “modified phenol resin” is intended to include phenol resins modified with a compound such as cashew oil, tall oil, linseed oil, an animal or vegetable oil of any type, an unsaturated fatty acid, rosin, alkyl benzene resin, aniline and melamine.

The phenolic resin preferably includes a modified phenol resin. In this case, larger composite spheres are formed, or harder composite spheres are formed because more sufficient hardness is provided as a result of the curing reaction. In particular, a cashew oil-modified phenol resin or rosin-modified phenol resin is more preferred.

Suitable examples of the cashew oil-modified phenol resin include those represented by the following formula (I).

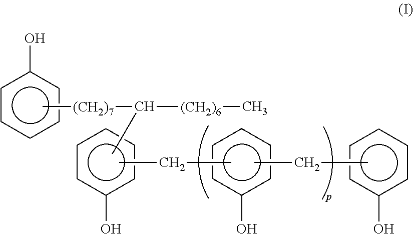

In the formula (I), p is an integer of 1 to 9 and is preferably 5 or 6 for high reactivity and improved dispersibility.

The phenolic resin preferably further includes a non-reactive alkyl phenol resin in addition to a phenol resin and/or a modified phenol resin. The non-reactive alkyl phenol resin is highly compatible with the phenol resin and modified phenol resin and prevents the composite spheres from becoming soft, so that deterioration of the handling stability can be avoided. In addition, good proccessability (in particular, adhesion) is provided. The term “non-reactive alkyl phenol resin” is intended to include alkyl phenol resins free from reactive sites ortho and para (in particular, para) to the hydroxyl groups of the benzene rings in the chain. Suitable examples of the non-reactive alkyl phenol resin include those represented by the following formulae (II) and (III).

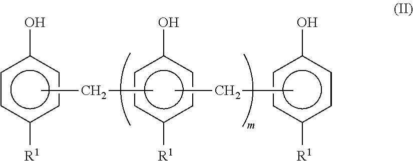

In the formula (II), m is an integer, and is preferably 1 to 10, and more preferably 2 to 9 for adequate blooming resistance. R¹s, which may be the same or different, each represent an alkyl group, and preferably represent a C₄₋₁₅ alkyl group, and more preferably a C₆₋₁₀ alkyl group for compatibility with rubber.

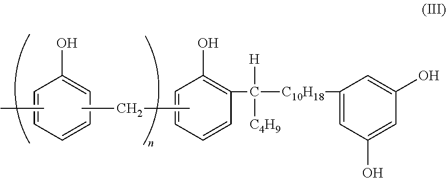

In the formula (III), n is an integer, and is preferably 1 to 10, and more preferably 2 to 9 for adequate blooming resistance.

The amount of the phenolic resin (the total amount of the above resins) is preferably not less than 5 parts by mass, and more preferably not less than 8 parts by mass based on 100 parts by mass of the rubber component. An amount of the phenolic resin of less than 5 parts by mass may result in insufficient hardness. The amount is preferably not more than 30 parts by mass, and more preferably not more than 25 parts by mass based on 100 parts by mass of the rubber component. An amount of more than 30 parts by mass tends to lead to low fuel economy.

The total amount of the phenol resin and modified phenol resin is preferably not less than 5 parts by mass, and more preferably not less than 8 parts by mass based on 100 parts by mass of the rubber component. A total amount of the phenol resin and modified phenol resin of less than 5 parts by mass may result in insufficient hardness. The total amount is preferably not more than 18 parts by mass, and more preferably not more than 16 parts by mass based on 100 parts by mass of the rubber component. A total amount of more than 18 parts by mass tends to lead to low fuel economy.

The amount of the non-reactive alkyl phenol resin is preferably not less than 0.2 parts by mass, and more preferably not less than 0.5 parts by mass based on 100 parts by mass of the rubber component. An amount of the non-reactive alkyl phenol resin of less than 0.2 parts by mass tends to result in low adhesion. The amount is preferably not more than 7 parts by mass, and more preferably not more than 5 parts by mass based on 100 parts by mass of the rubber component. An amount of more than 7 parts by mass tends to lead to low fuel economy, hardness and E*.

The rubber composition of the present invention typically contains a curing agent for curing the phenolic resin. The use of a curing agent results in formation of composite spheres in which the phenolic resin is cross-linked. As a result, the effects of the present invention are favorably provided. The curing agent is not particularly limited, provided that it has the curing ability mentioned above. Examples thereof include hexamethylenetetramine (HMT), hexamethoxymethylol melamine (HMMM), hexamethylol melamine pentamethyl ether (HMMPME), melamine and methylol melamine. Especially, HMT, HMMM and HMMPME are preferable because of their good ability to increase the hardness of the phenolic resin.

The lower limit of the amount of the curing agent is preferably not less than 1 part by mass, and more preferably not less than 5 parts by mass based on 100 parts by mass of the total amount of the phenol resin and modified phenol resin. The upper limit thereof is preferably not more than 50 parts by mass, and more preferably not more than 15 parts by mass. An amount of the curing agent of less than the lower limit may not allow curing to sufficiently proceed; and an amount of more than the upper limit may not allow curing to uniformly proceed, and may result in scorching in the extrusion process.

The rubber composition of the present invention may optionally contain compounding ingredients conventionally used in the rubber industry, in addition to the aforementioned ingredients. Examples of the compounding ingredients include oil, stearic acid, antioxidants of various types, zinc oxide, sulfur, vulcanization accelerators, and retarders.

In the present invention, good proccessability can be achieved without oil by using a specific carbon black and a phenolic resin in combination and optionally using appropriate amounts of SPB-containing BR and at least one of NR and IR. Therefore, the amount of oil can be reduced and higher levels of fuel economy and handling stability can be achieved. The amount of oil is preferably not more than 5 parts by mass, more preferably not more than 2 parts by mass, and further more preferably 0 part by mass based on 100 parts by mass of the rubber component.

The rubber composition of the present invention typically contains sulfur. For good handling stability, the amount of sulfur is preferably not less than 2 parts by mass, and more preferably not less than 4 parts by mass based on 100 parts by mass of the rubber component. The amount is preferably not more than 10 parts by mass, and more preferably not more than 8 parts by mass in terms of blooming of sulfur, adhesion and durability. The amount of sulfur herein refers to the amount of pure sulfur, and refers, in the case of insoluble sulfur, to the amount of sulfur excluding oil.

Commonly known methods can be employed as the method for producing the rubber composition of the present invention, and for example, the rubber composition can be produced by mixing and kneading the ingredients mentioned above with use of a rubber kneader such as an open roll mill or a Banbury mixer, and then vulcanizing the mixture.

The rubber composition of the present invention is used for a bead apex that is a component placed on the inner side of a clinch of a tire and extending radially outwardly from a bead core. Specifically, it is used, for example, for the components shown in FIGS. 1 to 3 of JP 2008-38140 A, and FIG. 1 of JP 2004-339287 A.

The pneumatic tire of the present invention can be produced by usual methods using the rubber composition. Specifically, before vulcanization, the rubber composition is extruded and processed into the shape of a bead apex, molded in a usual manner on a tire building machine, and then assembled with other tire components so as to form an unvulcanized tire. Then, the unvulcanized tire is heated and pressurized in a vulcanizer to produce a tire.

### EXAMPLES

The following will mention the present invention specifically with reference to Examples, but the present invention is not limited thereto.

The chemical agents used in Examples and Comparative Examples are listed below.

NR: TSR20

BR: VCA617 produced by Ube Industries, Ltd. (SPB-containing BR, ML₁₊₄ (100° C.): 62, boiling n-hexane-insoluble matter content: 17% by mass)

SBR: Emulsion-polymerized SBR (E-SBR) 1502 produced by JSR Corp. (styrene content: 23.5% by mass)

Carbon black: Table 1

Silica: Z115Gr produced by Rhodia

Alkyl phenol resin: SP1068 produced by NIPPON SHOKUBAI Co., Ltd. (non-reactive alkyl phenol resin represented by the formula (II) (m is an integer of 1 to 10 and R¹s are octyl groups))

TDAE oil: Vivatec 500 produced by H&R

Antioxidant: Nocrac 6C (6PPD) produced by Ouchi Shinko Chemical Industrial Co., Ltd.

Stearic acid: Product of NOF Corporation

Zinc oxide: Product of Mitsui Mining & Smelting Co., Ltd.

Insoluble sulfur: CRYSTEX HS OT20 produced by FLEXSYS (insoluble sulfur containing 80% by mass of sulfur and 20% by mass of oil)

Vulcanization accelerator: Nocceler NS produced by Ouchi Shinko Chemical Industrial Co., Ltd. (N-tert-butyl-2-benzothiazolylsulfenamide)

CTP: N-cyclohexylthio-phthalamide (CTP) produced by Ouchi Shinko Chemical Industrial Co., Ltd.

Modified phenol resin: PR12686 produced by Sumitomo Bakelite Co., Ltd. (cashew oil-modified phenol resin represented by the formula (I))

HMT (curing agent): Nocceler H produced by Ouchi Shinko Chemical Industrial Co., Ltd. (hexamethylenetetramine)

TABLE 1

| | | | BET | |
|---|---|---|---|---|
| | | COAN | (NSA) | OAN |
| | | (ml/100 g) | (m 2/g) | (ml/100 g) |
| Carbon | S247 (Evonik) | 102 | 42 | 178 |
| black (1) | | | | |
| Carbon | Prototype | 112 | 38 | 185 |
| black (2) | (MitsubishiChemicalCorp.) | | | |
| Carbon | N351H | 102 | 68 | 137 |
| black (3) | (MitsubishiChemicalCorp.) | | | |
| Carbon | N375 (Columbia Chemical) | 96 | 91 | 114 |
| black (4) | | | | |
| Carbon | N330 (Columbia Chemical) | 88 | 78 | 102 |
| black (5) | | | | |
| Carbon | N326 (Columbia Chemical) | 68 | 78 | 72 |
| black (6) | | | | |
| Carbon | N220 (Columbia Chemical) | 98 | 114 | 114 |
| black (7) | | | | |
| Carbon | N121 (Columbia Chemical) | 111 | 122 | 132 |
| black (8) | | | | |
| Carbon | N550 (Columbia Chemical) | 88 | 42 | 121 |
| black (9) | | | | |

### EXAMPLES AND COMPARATIVE EXAMPLES

The materials in amounts shown in Table 2 or 3, except the sulfur, vulcanization accelerator and curing agent, were kneaded in a 1.7-L Banbury mixer at 150° C. for five minutes to give a kneaded mixture. Thereafter, the sulfur, vulcanization accelerator and curing agent were added to the kneaded mixture and then the resulting mixture was kneaded with an open roll mill at 80° C. for three minutes to give an unvulcanized rubber composition. A portion of the unvulcanized rubber composition was press-vulcanized in a 2-mm-thick mold at 150° C. for 30 minutes to give a vulcanized rubber composition.

Another portion of the unvulcanized rubber composition was molded into the shape of a bead apex. The molded product was assembled with other tire components into an unvulcanized tire and the tire was press-vulcanized at 170° C. for 12 minutes to give a tire for sport utility vehicles (SUVs) (SUV tire, size: P265/65R17 110S).

A set of SUV tires produced in this manner was mounted on an SUV (displacement: 3500 cc) and the vehicle was driven for break-in for about one hour on a test course of running mode with circuit, zigzag and circumference roads.

The obtained unvulcanized rubber compositions, vulcanized rubber compositions, and SUV tires (new; and after break-in) were evaluated as follows. Tables 2 and 3 show the results.

### (Viscoelasticity Test)

The complex elastic modulus (E*) and loss tangent (tan δ) were measured for test samples prepared from the SUV tires using a viscoelasticity spectrometer (VES produced by Iwamoto Seisakusho Co., Ltd.) under the following conditions: a temperature of 70° C.; a frequency of 10 Hz; an initial strain of 10%; and a dynamic strain of 2%. A larger E* corresponds to higher rigidity and better handling stability; and a smaller tan δ corresponds to better fuel economy.

### (Handling Stability (Steering Response))

Each vehicle was driven on a dry asphalt test course (road surface temperature: 25° C.), and the handling stability (response of each vehicle to a minute change in the steering angle) during the driving was evaluated on a six-point scale based on sensory evaluation by a test driver. A higher point corresponds to better handling stability. The points “4+” and “5+” mean levels slightly higher than those of 4 and 5, respectively.

### (Rolling Resistance Test)

The rolling resistance was measured when the SUV tires (P265/65R17 110S, 17×7.5) were run at 25° C. on a drum under the following conditions: a load of 4.9 N; a tire internal pressure of 2.00 kPa; and a speed of 80 km/hour. The rolling resistance of Comparative Example 1 was used as a reference and the rolling resistance of each composition was expressed as an index relative to that of Comparative Example 1 by the following equation.

A larger negative index (smaller index) corresponds to more improved performance in terms of rolling resistance.

(Rolling resistance reduction ratio)={(rolling resistance of each composition)−(rolling resistance of Comparative Example 1)}/(rolling resistance of Comparative Example 1)×100

### (Extrusion Proccessability)

A portion of each unvolcanized rubber composition was extrusion-molded using an extrusion molding machine. Each of the extruded unvolcanized rubber compositions was molded into the shape of a bead apex, and the molded products were evaluated for their edge conditions by visual observation. A five-point scale evaluation (point: 1 to 5) was performed for the extruded shape evaluation. Specifically, “5” indicates a condition with a smoothest edge; and “1” indicates a condition with a most irregular edge. The evaluation point of each composition was expressed as an index relative to that of Comparative Example 1 regarded as 100. Accordingly, a larger index corresponds to better extrusion proccessability.

### (Adhesion Index)

A portion of each unvolcanized rubber composition was extrusion-molded into a bead apex. Each molded product was evaluated for adhesion between the rubber surface of the molded product and a carcass cord-covering rubber composition for tires (both of adhesion and flatness) based on sensory evaluation by a molding operator and the result was expressed as an index. A larger adhesion index corresponds to higher adhesion between the carcass and the bead apex and better molding proccessability. A smaller adhesion index corresponds to higher frequencies of separation between the carcass and the bead apex, and trapped air.

Generally, the adhesion depends on factors such as the extrusion temperature of a molded product (self-heating temperature), the type of an adhesive resin and the amount thereof, the type of a rubber component and the amount thereof.

TABLE 2

| | | | Examples | | | | | | | |
|---|---|---|---|---|---|---|---|---|---|---|
| | | | 1 | 2 | 3 | 4 | 5 | 6 | 7 | 8 |
| Components | NR | | 70 | 70 | 70 | 70 | 100 | 60 | 60 | 30 |
| (part(s) by mass) | BR | | — | — | — | — | — | 40 | 40 | 70 |
| | SBR | | 30 | 30 | 30 | 30 | — | — | — | — |
| | Carbon black (1) | | 60 | 60 | — | — | 60 | 60 | 56 | 56 |
| | Carbon black (2) | | — | — | 60 | 60 | — | — | — | — |
| | Carbon black (3) | | — | — | — | — | — | — | — | — |
| | Carbon black (4) | | — | — | — | — | — | — | — | — |
| | Carbon black (5) | | — | — | — | — | — | — | — | — |
| | Carbon black (6) | | — | — | — | — | — | — | — | — |
| | Carbon black (7) | | — | — | — | — | — | — | — | — |
| | Carbon black (8) | | — | — | — | — | — | — | — | — |
| | Carbon black (9) | | — | — | — | — | — | — | — | — |
| | Silica | | — | — | — | — | — | — | — | — |
| | Alkyl phenol resin | | 3 | 1 | 3 | 1 | 1 | 1 | 1 | 1 |
| | TDAE oil | | — | — | — | — | — | — | — | — |
| | Antioxidant | | 1 | 1 | 1 | 1 | 1 | 1 | 1 | 1 |
| | Stearic acid | | 3 | 3 | 3 | 3 | 3 | 3 | 3 | 3 |
| | Zinc oxide | | 8 | 8 | 8 | 8 | 8 | 8 | 8 | 8 |
| | Insoluble sulfur | | 7.5 | 7.5 | 7.5 | 7.5 | 7.5 | 7.5 | 7.5 | 7.5 |
| | (S content) | | (6) | (6) | (6) | (6) | (6) | (6) | (6) | (6) |
| | Vulcanization accelerator | | 3.7 | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 | 0.4 |
| | Modified phenol resin | | 10 | 10 | 10 | 10 | 10 | 10 | 10 | 10 |
| | HMT | | 1 | 1 | 1 | 1 | 1 | 1 | 1 | 1 |
| Evaluations | New | E* | 43 | 47 | 44 | 48 | 46 | 50 | 47 | 50 |
| | | Steering response | 5 | 6 | 5+ | 6 | 6 | 6 | 6 | 6 |
| | | Tan δ 70° C. | 0.12 | 0.112 | 0.119 | 0.108 | 0.105 | 0.11 | 0.104 | 0.12 |
| | | Rolling resistance | −1 | −1.2 | −1.1 | −1.8 | −1.9 | −1.7 | −2 | −1.1 |
| | | reduction ratio | | | | | | | | |
| | | (%) | | | | | | | | |
| | After break-in | E* | 41 | 46 | 42 | 47 | 45 | 49 | 47 | 48 |
| | | Steering response | 4+ | 6 | 5+ | 6 | 6 | 6 | 6 | 5+ |
| | Processability | Extruded shape | 105 | 100 | 100 | 95 | 100 | 110 | 115 | 105 |
| | | index | | | | | | | | |
| | | Adhesion index | 100 | 80 | 100 | 80 | 95 | 110 | 110 | 95 |

| | | | Examples | | | | | | |
|---|---|---|---|---|---|---|---|---|---|
| | | | 9 | 10 | 11 | 12 | 13 | 14 | 15 |
| Components | NR | | 100 | 60 | 60 | 60 | 70 | 70 | 70 |
| (part(s) by mass) | BR | | — | 40 | 40 | 40 | — | — | — |
| | SBR | | — | — | — | — | 30 | 30 | 30 |
| | Carbon black (1) | | — | 56 | 56 | 66 | 70 | 70 | 60 |
| | Carbon black (2) | | 60 | — | — | — | — | — | — |
| | Carbon black (3) | | — | — | — | — | — | — | — |
| | Carbon black (4) | | — | — | — | — | — | — | — |
| | Carbon black (5) | | — | — | — | — | — | — | — |
| | Carbon black (6) | | — | — | — | — | — | — | — |
| | Carbon black (7) | | — | — | — | — | — | — | — |
| | Carbon black (8) | | — | — | — | — | — | — | — |
| | Carbon black (9) | | — | — | — | — | — | — | — |
| | Silica | | — | — | — | — | — | — | 5 |
| | Alkyl phenol resin | | 1 | 1 | 1 | 1 | 3 | 3 | 3 |
| | TDAE oil | | — | — | 2 | — | — | — | — |
| | Antioxidant | | 1 | 1 | 1 | 1 | 1 | 1 | 1 |
| | Stearic acid | | 3 | 3 | 3 | 3 | 3 | 3 | 3 |
| | Zinc oxide | | 8 | 8 | 8 | 8 | 8 | 8 | 8 |
| | Insoluble sulfur | | 7.5 | 7.5 | 7.5 | 7.5 | 7.5 | 5 | 7.5 |
| | (S content) | | (6) | (6) | (6) | (6) | (6) | (4) | (6) |
| | Vulcanization accelerator | | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 |
| | Modified phenol resin | | 10 | 15 | 15 | 7 | 10 | 15 | 10 |
| | HMT | | 1 | 1.5 | 1.5 | 0.7 | 1 | 1.5 | 1 |
| Evaluations | New | E* | 47 | 50 | 46 | 48 | 51 | 48 | 42 |
| | | Steering response | 6 | 6 | 6 | 6 | 6 | 6 | 5 |
| | | Tan δ 70° C. | 0.104 | 0.107 | 0.097 | 0.122 | 0.14 | 0.15 | 0.127 |
| | | Rolling resistance | −1.9 | −1.9 | −2.3 | −0.9 | −0.1 | 0 | −0.7 |
| | | reduction ratio (%) | | | | | | | |
| | After break-in | E* | 47 | 50 | 45 | 47 | 50 | 47 | 40 |
| | | Steering response | 6 | 6 | 5+ | 6 | 6 | 6 | 4+ |
| | Processability | Extruded shape index | 95 | 115 | 120 | 105 | 85 | 85 | 105 |
| | | Adhesion index | 95 | 110 | 120 | 105 | 90 | 95 | 105 |

TABLE 3

| | | | Comparative Examples | | | | | | |
|---|---|---|---|---|---|---|---|---|---|
| | | | 1 | 2 | 3 | 4 | 5 | 6 | 7 |
| Components | NR | | 70 | 70 | 70 | 70 | 70 | 70 | 70 |
| (part(s) by mass) | BR | | — | — | — | — | — | — | — |
| | SBR | | 30 | 30 | 30 | 30 | 30 | 30 | 30 |
| | Carbon black (1) | | — | — | — | — | — | — | — |
| | Carbon black (2) | | — | — | — | — | — | — | — |
| | Carbon black (3) | | — | — | 60 | — | — | — | — |
| | Carbon black (4) | | — | — | — | 60 | — | — | — |
| | Carbon black (5) | | — | — | — | — | 60 | — | — |
| | Carbon black (6) | | — | — | — | — | — | 60 | — |
| | Carbon black (7) | | — | — | — | — | — | — | 60 |
| | Carbon black (8) | | — | — | — | — | — | — | — |
| | Carbon black (9) | | 70 | 70 | — | — | — | — | — |
| | Silica | | — | — | — | — | — | — | — |
| | Alkyl phenol resin | | 3 | 1 | 3 | 3 | 3 | 3 | 3 |
| | TDAE oil | | — | — | — | — | — | — | — |
| | Antioxidant | | 1 | 1 | 1 | 1 | 1 | 1 | 1 |
| | Stearic acid | | 3 | 3 | 3 | 3 | 3 | 3 | 3 |
| | Zinc oxide | | 8 | 8 | 8 | 8 | 8 | 8 | 8 |
| | Insoluble sulfur | | 7.5 | 7.5 | 7.5 | 7.5 | 7.5 | 7.5 | 7.5 |
| | (S content) | | (6) | (6) | (6) | (6) | (6) | (6) | (6) |
| | Vulcanization accelerator | | 3.7 | 3.7 | 3.7 | 3.7 | 3.7 | 3.7 | 3.7 |
| | CTP | | 0.4 | 0.4 | 0.4 | 0.4 | 0.4 | 0.4 | 0.4 |
| | Modified phenol resin | | 10 | 10 | 10 | 10 | 10 | 10 | 10 |
| | HMT | | 1 | 1 | 1 | 1 | 1 | 1 | 1 |
| Evaluations | New | E* | 40 | 42 | 49 | 51 | 42 | 39 | 52 |
| | | Steering response | 5 | 5 | 6 | 6 | 5 | 4+ | 6 |
| | | Tan δ 70° C. | 0.149 | 0.135 | 0.151 | 0.166 | 0.165 | 0.155 | 0.179 |
| | | Rolling resistance | 0 | −0.2 | 0 | 0.9 | 1.1 | 0.2 | 1.8 |
| | | reduction ratio | | | | | | | |
| | | (%) | | | | | | | |
| | After break-in | E* | 35 | 37 | 45 | 47 | 36 | 35 | 47 |
| | | Steering response | 3 | 4 | 5 | 5 | 3+ | 3 | 5 |
| | Processability | Extruded shape | 100 | 95 | 85 | 90 | 95 | 105 | 85 |
| | | index | | | | | | | |
| | | Adhesion index | 100 | 80 | 100 | 100 | 100 | 100 | 90 |

| | | | Comparative Examples | | | | | |
|---|---|---|---|---|---|---|---|---|
| | | | 8 | 9 | 10 | 11 | 12 | 13 |
| Components | NR | | 70 | 70 | 70 | 60 | 60 | 70 |
| (part(s) by mass) | BR | | — | — | — | 40 | 40 | — |
| | SBR | | 30 | 30 | 30 | — | — | 30 |
| | Carbon black (1) | | — | — | — | — | — | — |
| | Carbon black (2) | | — | — | — | — | — | — |
| | Carbon black (3) | | — | — | — | — | — | — |
| | Carbon black (4) | | — | — | — | — | — | 70 |
| | Carbon black (5) | | — | — | — | — | — | — |
| | Carbon black (6) | | — | — | — | — | — | — |
| | Carbon black (7) | | — | — | — | — | — | — |
| | Carbon black (8) | | 60 | — | — | — | — | — |
| | Carbon black (9) | | — | 70 | 70 | 70 | 70 | — |
| | Silica | | — | — | — | — | — | — |
| | Alkyl phenol resin | | 3 | — | 3 | 1 | 1 | 3 |
| | TDAE oil | | — | 3 | — | — | — | — |
| | Antioxidant | | 1 | 1 | 1 | 1 | 1 | 1 |
| | Stearic acid | | 3 | 3 | 3 | 3 | 3 | 3 |
| | Zinc oxide | | 8 | 8 | 8 | 8 | 8 | 8 |
| | Insoluble sulfur | | 7.5 | 7.5 | 7.5 | 7.5 | 7.5 | 5 |
| | (S content) | | (6) | (6) | (6) | (6) | (6) | (4) |
| | Vulcanization accelerator | | 3.7 | 3.7 | 3.7 | 3.7 | 3.7 | 3.7 |
| | CTP | | 0.4 | 0.4 | 0.4 | 0.4 | 0.4 | 0.4 |
| | Modified phenol resin | | 10 | 10 | 15 | 10 | 15 | 10 |
| | HMT | | 1 | 1 | 1.5 | 1 | 1.5 | 1 |
| Evaluations | New | E* | 54 | 36 | 46 | 45 | 50 | 50 |
| | | Steering response | 6 | 4 | 6 | 5+ | 6 | 6 |
| | | Tan δ 70° C. | 0.201 | 0.132 | 0.162 | 0.128 | 0.135 | 0.181 |
| | | Rolling resistance | 2.2 | −0.3 | 0.8 | −0.5 | −0.2 | 1.9 |
| | | reduction ratio (%) | | | | | | |
| | After break-in | E* | 47 | 32 | 42 | 42 | 47 | 47 |
| | | Steering response | 5 | 3 | 4+ | 4+ | 5 | 5 |
| | Processability | Extruded shape index | 60 | 105 | 100 | 105 | 105 | 70 |
| | | Adhesion index | 70 | 80 | 100 | 100 | 100 | 80 |

Regarding Examples in which a specific carbon black and a phenolic resin were used, the handling stability and fuel economy were improved in a balanced manner, and deterioration of the handling stability could be avoided (resistance to permanent set of compound was improved). In addition, the proccessability was good. Particularly, the compositions of Examples in which SPB-containing BR was used in combination were remarkably good as evidenced by low friction, low extrusion temperature, and high cohesiveness of the rubber compositions.

Compared to the compositions of Examples, the compositions of Comparative Examples were poor in the performances.

1. A bead apex rubber composition comprising:
a rubber component;
a carbon black; and
a phenolic resin,
wherein the carbon black has a COAN of 95 to 130 ml/100 g and a BET specific surface area of 25 to 50 m²/g.

2. The bead apex rubber composition according to claim 1,
wherein the phenolic resin is a phenol resin and/or a modified phenol resin.

3. The bead apex rubber composition according to claim 2,
wherein an amount of the carbon black is 40 to 80 parts by mass, and a total amount of the phenol resin and modified phenol resin is 5 to 18 parts by mass based on 100 parts by mass of the rubber component.

4. The bead apex rubber composition according to claim 1,
wherein the rubber component includes butadiene rubber and at least one of natural rubber and isoprene rubber, and
an amount of the butadiene rubber is 20 to 80% by mass in 100% by mass of the rubber component.

5. The bead apex rubber composition according to claim 1, comprising sulfur in an amount of 4 to 8 parts by mass based on 100 parts by mass of the rubber component.

6. A pneumatic tire comprising a bead apex produced from the rubber composition according to claim 1.

7. A pneumatic tire comprising a bead apex produced from the rubber composition according to claim 2.

8. A pneumatic tire comprising a bead apex produced from the rubber composition according to claim 3.

9. A pneumatic tire comprising a bead apex produced from the rubber composition according to claim 4.

10. A pneumatic tire comprising a bead apex produced from the rubber composition according to claim 5.
